(19) United States
(12) Patent Application Publication
(10) Pub. No.: US 2014/0184605 A1
(43) Pub. Date: Jul. 3, 2014

(54) BOWTIE CHARTS FOR IDENTIFYING PROBLEMS AND SOLUTIONS IN A COMPLEX MECHANICAL SYSTEM

(71) Applicant: The Boeing Company, (US)

(72) Inventor: Roger K. Bolton, Madison, AL (US)

(73) Assignee: THE BOEING COMPANY, Chicago, IL (US)

(21) Appl. No.: 13/732,646

(22) Filed: Jan. 2, 2013

(51) Int. Cl. G06T 11/20

(52) U.S. Cl. CPC G06T 11/206
USPC 345/440

(57) ABSTRACT

A method comprises characterizing a complex mechanical system in terms of functions, and using a computer system to display and fill in bowtie charts to identify problems and solutions with respect to the functions.

The invention described herein was made in the performance of work under NASA Contract No. NNM07AB03C and is subject to the provisions of Section 305 of the National Aeronautics and Space Act of 1958 (72 Stat. 435: 42 U.S.C. 2457).

### BACKGROUND

In a complex mechanical system, problems may occur at a system level, subsystem level and component level. Analytical tools for identifying the problems and corresponding solutions in complex mechanical systems are extremely valuable.

Many of the current tools for system analysis were developed for software-intensive systems. However, these tools are not readily adaptable for the analysis of mechanical systems, especially those mechanical systems having many sophisticated mechanical components. Better tools are needed.

### SUMMARY

According to an embodiment herein, a method comprises characterizing a complex mechanical system in terms of functions, and using a computer system to display and fill in bowtie charts to identify problems and solutions with respect to the functions.

According to another embodiment herein, a graphical bowtie chart for analyzing a complex mechanical system is generated by a computer. The chart comprises a name of a persistent function of the system at a knot, a set of causes on a first side of the knot, a corresponding set of results on a second side of the knot, at least one reason entry between each cause and the knot, and at least one solution entry between each result and the knot.

According to another embodiment herein, a system comprises at least one computer programmed to receive characterizations of a complex mechanical system in terms of functions, and construct charts that identify problems and solutions with respect to the functions. Each chart includes a name of one of the functions at a knot, a set of causes on a first side of the knot, a corresponding set of results on a second side of the knot, at least one reason between each cause and the knot, and at least one solution between each result and the knot.

According to another embodiment herein, an article comprises computer-readable memory encoded with data for causing a computer system to receive characterizations of a complex mechanical system in terms of functions; and construct bowtie charts that identify problems and solutions with respect to the functions.

These features and functions may be achieved independently in various embodiments or may be combined in other embodiments. Further details of the embodiments can be seen with reference to the following description and drawings.

### BRIEF DESCRIPTION OF THE DRAWINGS

FIG. 1 is an illustration of a complex mechanical system.

FIG. 2 is an illustration of a method of identifying problems and solutions in a complex mechanical system.

FIGS. 3A-3D are illustrations of a method of forming a bowtie chart, which is used to identify problems and solutions in a complex mechanical system.

FIG. 4 is an illustration of different arrangements of bowtie charts.

FIG. 5 is an illustration of a bowtie chart for a space launch vehicle.

FIGS. 6A-6C are illustrations of different methods of using a bowtie chart to identify problems and solutions in a complex mechanical system.

FIG. 7 is an illustration of a system for identifying problems and solutions in a complex mechanical system.

### DETAILED DESCRIPTION

A system may be characterized as a construct or collection of different components that together produce results not obtainable by the components alone. These components may include, without limitation, people, hardware, software, facilities, policies, and documents. A complex mechanical system as used herein refers to a system including sophisticated mechanical components (and optionally system logic) that is difficult to comprehend without the aid of analytical tools. Examples of complex mechanical systems include, but are not limited to, space launch systems, commercial aircraft, missile defense systems, satellites, biomedical devices, nuclear plants, automotive systems, and large construction projects such as bridges.

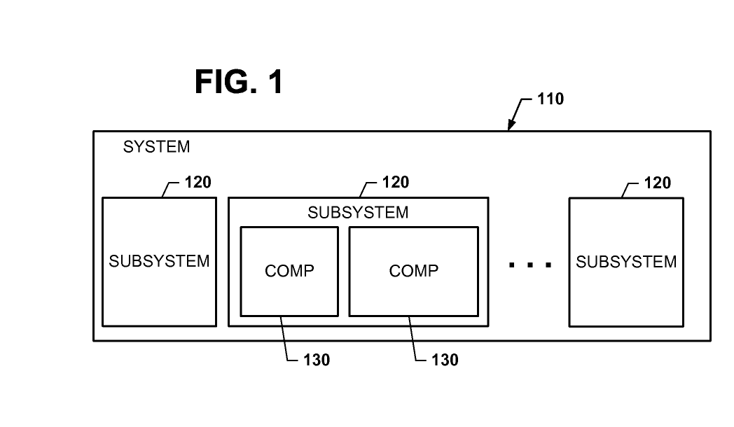

Reference is made to FIG. 1, which illustrates a complex mechanical system 110. The system 110 includes a plurality of subsystems 120, and each subsystem 120 may include additional subsystems. Each subsystem includes a large number of components 130. The subsystems 120 produce results not obtainable by the components 130 alone, and the system 110 produces results not obtainable by the subsystems 120 alone.

In the paragraphs that follow, reference will be made to a space launch system that includes the following subsystems: an engine, booster stage, one or more rocket stages, one or more command and control systems, and payload. This is done for illustrative purposes. The space launch system is but one example of a complex mechanical system. The system 110 is not limited to anything in particular.

The complex system 110 may be characterized in terms of functions. The functions in the complex system 110 include persistent functions, which are inherent in the system or intrinsic to the nature of the system. Examples of subsystem-level persistent functions for a space launch system may include power transfer switching from one power source (e.g., ground) to another source (on-board battery power), providing internal access for nominal operations and repair operations, and dealing with Electromagnetic Environmental Effects (E3). There may be persistent functions on a system level (across subsystems), on a subsystem level, and on a component level.

Now consider a commercial aircraft, which is designed for operation at an altitude of 30,000 feet above sea level. An example of a system-level persistent function may be flying through a harsh environment that lacks oxygen.

The functions in the complex system 110 also include transitional functions, which are functions that usually require actions. Typically, transitional functions are performed to operate within the environments controlled by the persistent functions. Examples of transitional functions for a space launch vehicle include updating software, providing guidance, navigation and control measurements, and providing a vehicle timekeeping source.

Characterizing the complex mechanical system 110 in terms of functions is known in the art as “functional modeling.” Examples of common functional modeling techniques include, but are not limited to, IDEF0 Functional Modeling method, which is designed to model the decisions, actions, and activities of an organization or system; Systems Modeling Language (“SysML”), which is a general-purpose modeling language for systems engineering applications; and Unified Modeling Language (“UML”), which is a standardized general-purpose modeling language for object-oriented software engineering.

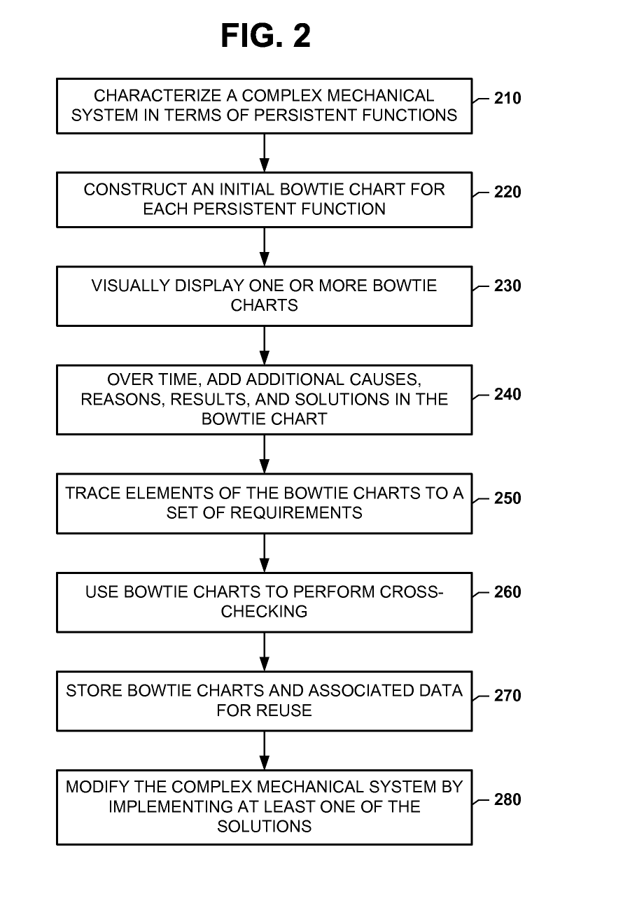

Reference is now made to FIG. 2, which illustrates a method of identifying problems and solutions in a complex mechanical system. At block 210, the complex mechanical system is characterized in terms of persistent functions. For example, persistent functions might be derived from mission operations, mission success criteria (e.g., reliability, availability), induced environments (e.g., dynamic loads), and operating environments (e.g., aerodynamics, acoustics). These functions may be identified using system engineering techniques such as use case analysis, IDEF0, Functional Flow Diagrams (FFBD), requirements workshops, and architectural reviews.

Consider the example of the space launch system. The system may be characterized in terms of the following four types of persistent functions:
Persistent Functions due to the Mission Operations. These operations include instrumentation mounting, vehicle servicing, launch countdown, propellant loading, and hazardous gas detection.
Persistent Functions due to Mission Success Criteria. These criteria include failure tolerance, reliability, minimum service life, and availability.
Persistent Functions due to Induced Environments. These functions address issues including aerodynamics, aerothermal, shock, vibration, and Electromagnetic Interference and Compatibility (EMI/EMC).
Persistent Functions due to Operating Environments. These functions address issues including transportation loads, static loads, and atmospheric conditions.

At block 220, a computer system is used to construct an initial bowtie chart for each persistent function. A bowtie chart is a graphical illustration of a problem with a function at a knot (e.g., center of the chart), first rays extending from a first side of the knot, and second rays extending from a second side of the knot. For instance, the first rays may extend outward from the left hand side (LHS) of the knot, and the second rays may extend outward from the right hand side (RHS) of the knot.

Each first ray on the first side terminates in a major cause of a problem with the function. Reasons are decomposed along each first ray. All reasons along a first ray are related to the cause at the end of the first ray. The reasons on the first side may be regarded as inputs to the function.

Each second ray on the second side corresponds to a first ray on the first side. Each second ray terminates in a result that would be created by the reasons along the corresponding first ray. Solutions are decomposed along each second ray. All solutions along a second ray are related to the result at the end of the second ray.

The computer system may generate the initial bowtie chart for a persistent function by starting with a blank template, filling in the function at the knot, and filling in known causes, reasons, results and solutions. Initially, one or more causes and reasons may be added on the first rays on the first side of the bowtie chart. Then, reasons for each major cause may be decomposed along each first ray. Next, solutions may be added to the second rays in a similar manner. For each first ray on the first side, there is a second ray on the second side that identifies how the cause on the first ray is dealt with by the persistent function at the knot.

At block 230, one or more of the bowtie charts are visually displayed. For instance, a bowtie chart may be projected on a screen or monitor, or it may be printed out.

The bowtie charts help to visualize problems in the complex system 110. They also help to identify solutions to the problems. The first side identifies areas where problems can occur. The second side identifies solutions to the problems. Bowtie charts also indentify correspondence between causes/reasons and results/solutions.

The bowtie charts also help identify areas where solutions are needed. An unfilled box between a function and result identifies the need for a solution. As a first example, if the first side has more rays than the second side, a misshapen bowtie chart will result. In this manner, the bowtie chart can serve as a fast visual check on the completeness of the analysis of the system 110. As a second example, a large unwieldy bowtie chart may indicate that the functionality of the system is poorly modeled, indicating that additional effort is needed to further decompose and abstract the function into more meaningful causes.

At block 240, over time, other causes and reasons may be identified, entered into the computer system, and added to the bowtie chart. As other causes and reasons are identified, their corresponding results and solutions are entered into the computer system and added to the bowtie charts.

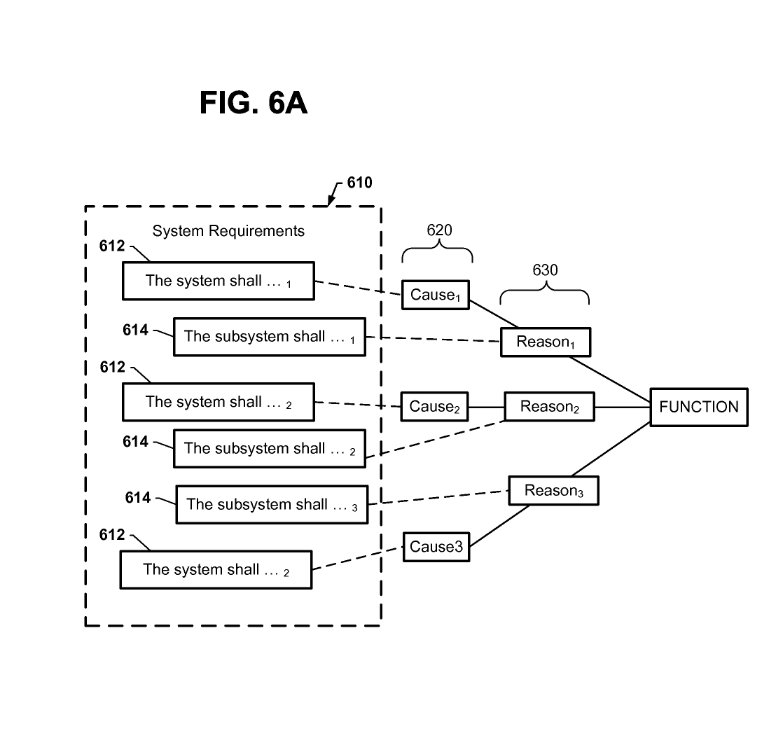

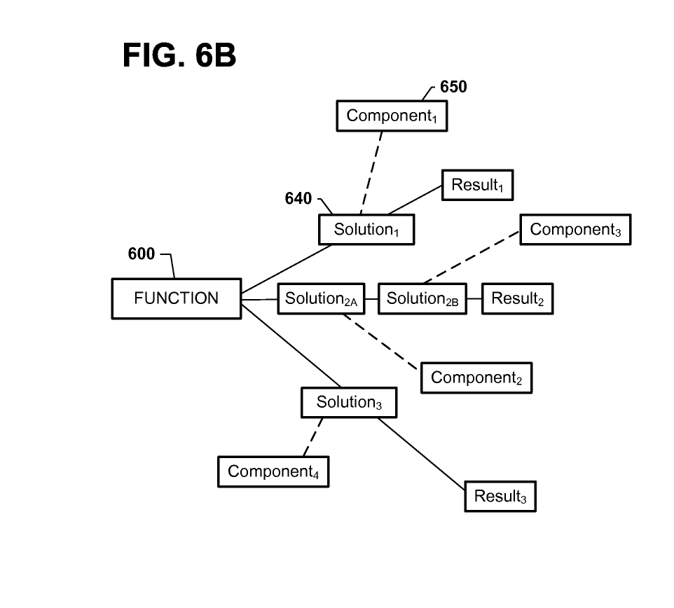

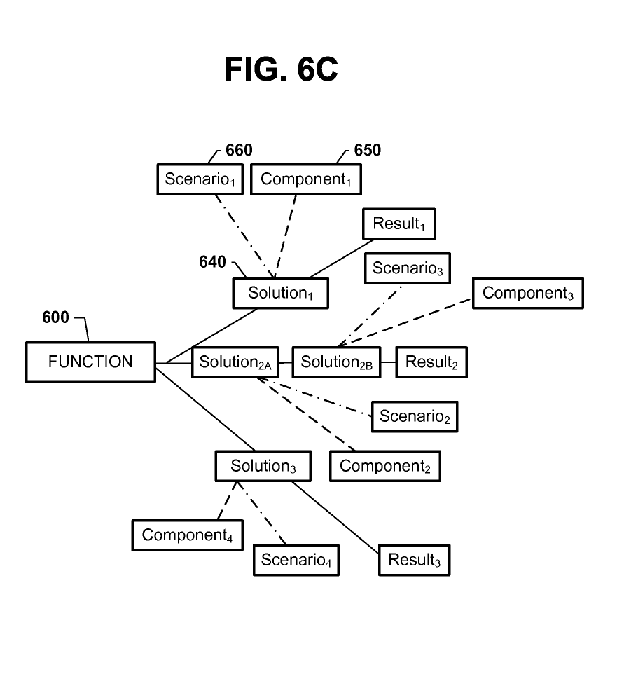

At block 250, the computer system may trace elements of each bowtie chart to a set of requirements. The major causes are traced to system level requirements, and the reasons are traced to subsystem or component requirements. The results and solutions are similarly traced. In this manner, the system, subsystems and components are traced to a physical hierarchy that represents the system 110 and to scenarios that explain the functionality behind the overall activities going on in the system 110. Examples of tracing are illustrated in FIGS. 6A and 6B and described below.

At block 260, each bowtie chart may be used to perform cross-checking. The cross-checking may include determining whether the solutions fulfill customer requirements and specifications, and whether any solutions go beyond the requirements and specifications. An example of cross-checking is illustrated in FIG. 6C and described below.

Although shown as occurring after block 240, the functions at block 250 ad 260 may be performed any time a cause, reason, result or solution are added to a bowtie chart.

At block 270, bowtie charts and associated data may be stored for reuse. Patterns may emerge as the bowtie charts are applied to understanding systems across numerous projects. Catalogs of bowtie charts may be generated for commonly used functions.

At block 280, the complex mechanical system may be modified by implementing any of the solutions identified in the bowtie chart. Consider an example where structural deformation has been identified as a reason for excessive material stress, increased wall thickness has been identified as a solution, and the solution has been traced to a component. The modification may include increasing the wall thickness of that component.

The method of FIG. 2 is described in connection with persistent functions. However, the method of FIG. 2 may also be used to analyze transitional functions.

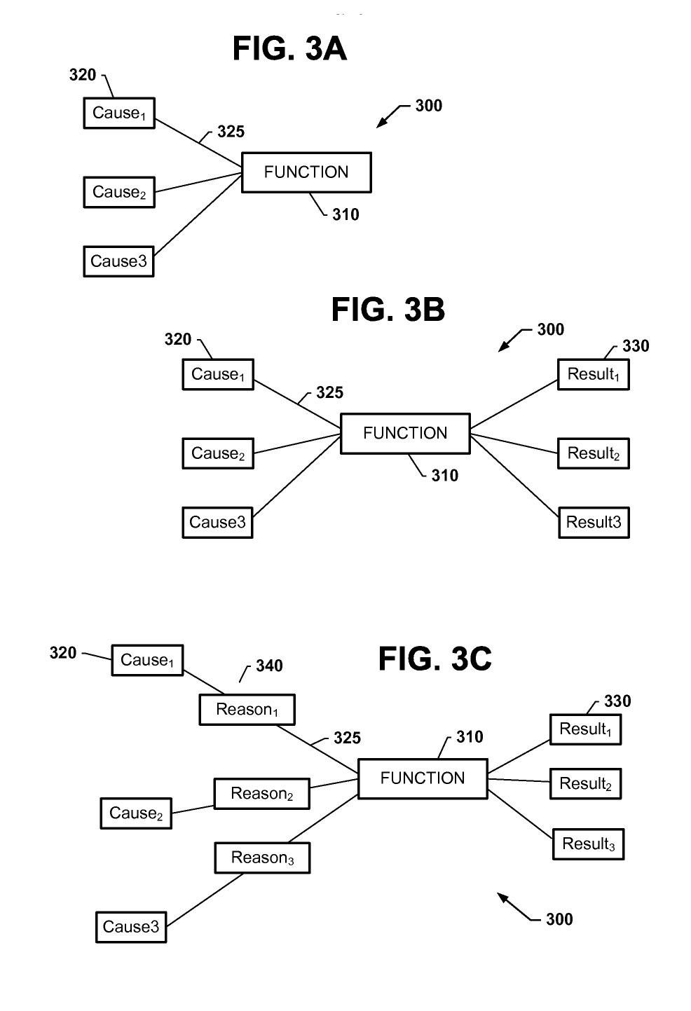

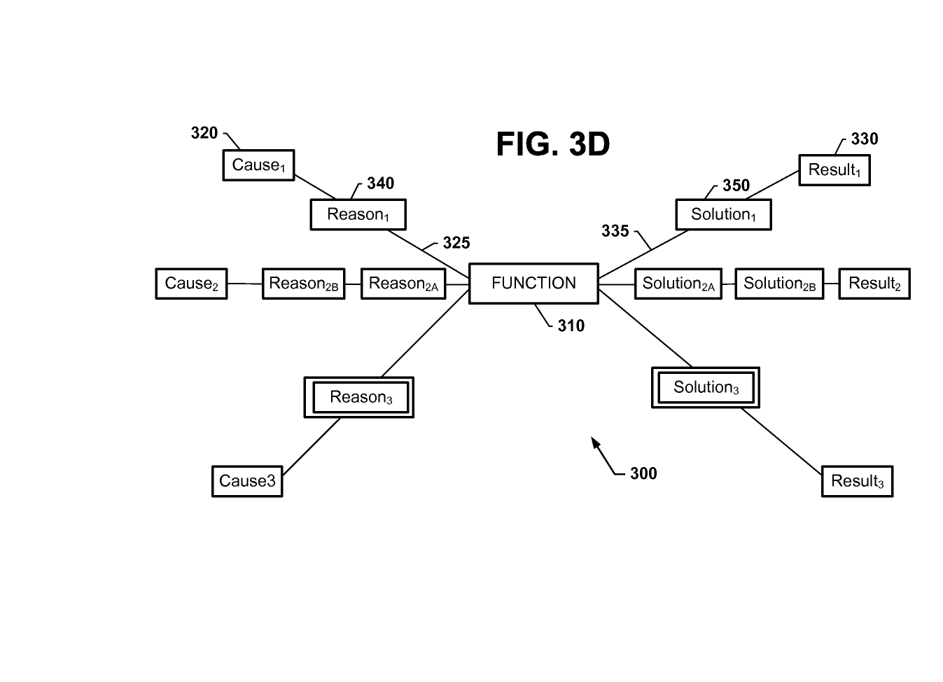

Reference is now made to FIGS. 3A-3D, which illustrate an example of a method of forming a bowtie chart 300 for a persistent function. In FIG. 3A, a name of the function is placed in a box 310 at the knot (e.g., center) of the chart 300. Each major cause of a problem with that function is placed in a box 320 on the LHS of the knot. A ray 325 is drawn from the function box 310 to each major cause box 320 on the LHS. FIG. 3A shows three rays 325, each terminating at a major cause box 320.

In FIG. 3B, a box 330 corresponding to each cause box 320 is placed on the RHS of the knot. Each box 330 on the RHS describes a result that corresponds to a cause box 320. For instance, each box 330 describes a result of a problem that would occur had the corresponding cause not been addressed. A ray 335 is drawn from the function box 310 to each result box 330. FIG. 3B shows symmetry of the left and right hand sides with respect to the knot.

In FIG. 3C, boxes 340 describing reasons for the causes are added to the LHS of the knot. Initially, a single reason box 340 may be assigned to each cause. Each reason box 340 may be located along the ray 325 extending to its corresponding cause box 320. As the function is analyzed, that single reason box 340 may be decomposed into multiple reason boxes.

In FIG. 3D, boxes 350 describing solutions to the problems are added to the RHS of the knot. There may be one or more solutions per result. Initially, a single solution box 350 is provided for each result. Each solution box 350 may be inserted along the ray 335 to its corresponding result box 330.

As the function is analyzed, that single solution box 350 may be decomposed into multiple reason boxes. For instance, FIG. 3D shows two reasons (Reason_{2A} and Reason_{2B}) for one of the causes (Cause₂), and two corresponding solutions (Solution_{2A} and Solution_{2B}) for the corresponding result (Result₂).

FIGS. 3C and 3D show one-to-one representations of causes-to-reasons and one-to-one representations of results-to-solutions. FIG. 3D also shows a one-to-many representation of causes-to-reasons and a one-to-many representation of results-to-solutions. However, a bowtie chart herein may also have many-to-one representations. In a many-to-one representation, reasons in one bowtie chart are connected to causes in another bowtie chart. In some instances, the cause or reason behind a function may also be part of causes that also occur across other persistent functions in the complex mechanical system. In these instances, causes and reasons may be shared among different bowtie charts for different functions. Shared causes and reasons may increase the understanding of the real dynamics of the complex mechanical system. Similarly, solutions in one bowtie chart may be connected to results in other bowtie charts.

These shared objects may be represented differently in a bowtie chart. For instance, FIG. 3D shows shared objects having different borders (Reason₃ and Solution₃). By selecting a shared object (e.g., by clicking on a shared object with a mouse), additional details may be displayed. For example, other functions sharing the selected object may be revealed.

The number and complexity of rays 325 and 335 will vary between different bowtie charts. Moreover, the shape of each bowtie chart will vary from function to function. For instance, a bowtie chart for a function that is not well-understood or decomposed at the correct abstraction layer may appear as a string tie, thus giving a quick indication that additional efforts are required to complete it. A bowtie chart for a very complicated function may appear as a very large, unwieldy bowtie, thus serving as an indicator that additional effort is needed to further decompose and abstract the function into more meaningful causes.

FIGS. 3A-3D describe the bowtie chart in terms of causes, reasons, results, and solutions. However, other embodiments may use different nomenclature.

The assignment of LHS and RHS may be done through established convention. FIGS. 3A-3D show the causes and reasons on the left hand side of the knot, and the results and solutions on the right hand side. In other embodiments, the chart may be arranged differently.

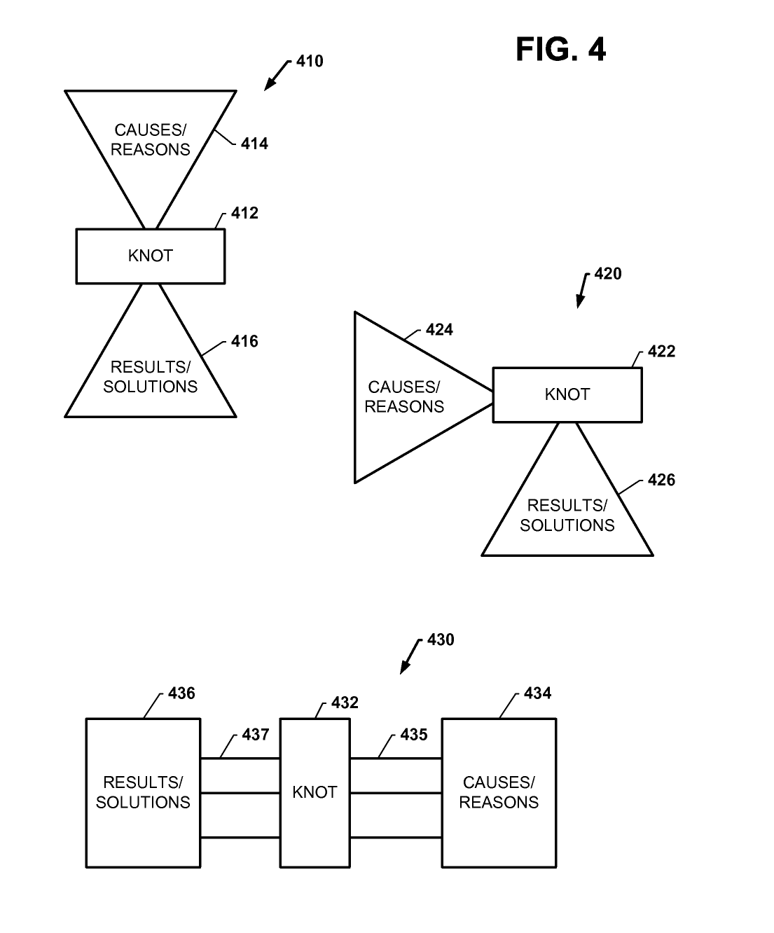

For instance, FIG. 4 shows three examples of some different arrangements of bowtie charts. The first bowtie chart 410 has a knot 412 at the center, causes/reasons 414 at the top, and results/solutions 416 at the bottom. The second bowtie chart 420 has a knot 422, causes/reasons 424 at the left hand side, and results/solutions 426 at the bottom. In both examples, the rays extend radially outward of the knots 412 and 422 (as represented by the triangular shapes).

The third bowtie chart 430 has a knot 432 at the center, causes/reasons 434 on the right hand side, and results/solutions 416 on the left hand side. The rays 435 and 437 are normal to the knot 432.

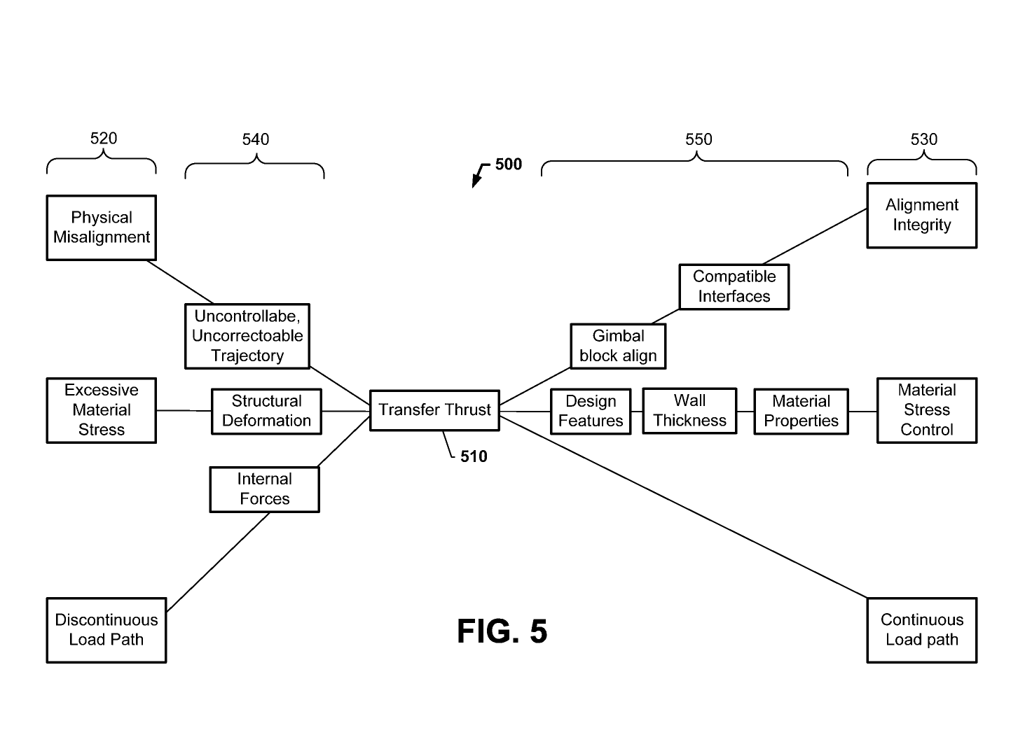

FIG. 5 describes an example of a bowtie chart 500 for a space launch vehicle. At the knot is a box 510 labeled “Transfer Thrust.” This persistent function deals with what must be considered at that point in time when massive amounts of energy are applied towards making the space vehicle start to escape the earth's atmosphere. Cause boxes 520 are labeled for “Physical Misalignment,” “Excessive Material Stress,” and “Discontinuous Load Path.” Corresponding result boxes 530 are filled in with “Alignment Integrity,” “Material Stress Control,” and “Continuous Load Path.”

There may be one or more reasons per cause. However, FIG. 5 shows only a single reason box 540 per cause. Uncontrollable, uncorrectable trajectory is identified as a reason for physical misalignment; structural deformation is identified as a reason for excessive material stress; and internal forces are identified as a reason for discontinuous load path.

There may be one or more solutions per result. FIG. 5 shows two solution boxes 550 (gimbal block alignment, and compatible interfaces) for alignment integrity, and three solution boxes 550 (design features, wall thickness, and material properties) for material stress control. FIG. 5 also shows that a solution is still needed for a continuous load path problem.

FIG. 6A illustrates a method of tracing the causes to a set of system requirements 610. The system requirements 610 include a set of statements 612 that specify functions performed at the system level and subsystem level. Each system-level statement 612 is traced to a cause 620, while each subsystem-level statement 614 is traced to a reason 630. The tracing is performed to ensure that the correct abstraction level exists in the requirements hierarchy.

FIG. 6B illustrates a method of tracing a solution 640 to a component 650 that implements the solution 640. For each solution 640, a component 650 is identified (four solutions 640 and four corresponding components 650 are illustrated in FIG. 6B). If a solution 640 is not traced to a corresponding component 650, then the function 600 has not been correctly studied since the functionality that is being implemented has not been discerned as to where or what is implementing it in the system. Therefore, additional effort is made to either better understand the function 600 or the requirement for that function 600.

FIG. 6C illustrates a method of cross-checking to determine whether the solutions 640 fulfill customer requirements and specifications, and whether any solutions 640 go beyond those requirements and specifications. For each solution 640, a scenario 660 is identified for which the system would use the solution 640. If a solution 640 does not have a corresponding scenario 660, then that solution 640 is investigated as to whether it goes beyond customer requirements and specifications.

The tracing and cross-checking may be performed by manual inputs to the computer system. For instance, the cross-checking and tracing may be accomplished via common computer graphic techniques such as copy/paste, drag-n-drop, and/or menus.

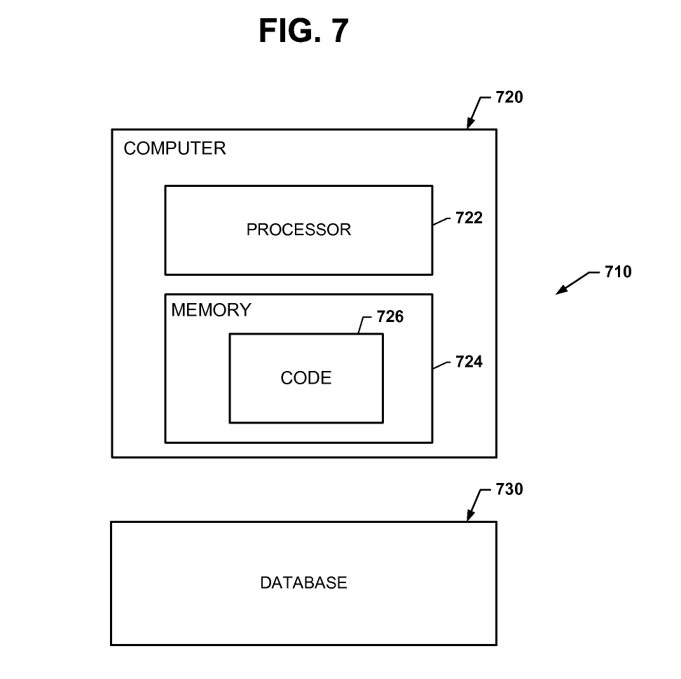

FIG. 7 is an illustration of a computer system 5710 for performing the method of FIG. 2. The system 710 includes at least one computer 720 and database 730. The computer 720 is not limited to anything in particular. Examples of a computer 720 include, but are not limited to, a desktop computer, workstation, and mobile station (e.g., mobile computer, handheld device).

Each computer 720 includes a processor 722 and computer-readable memory 724. The memory 724 is encoded with code 726 that, when executed, causes the processor 722 to receive characterizations of a complex mechanical system in terms of functions, and construct bowtie charts that identify problems and solutions with respect to each of the functions. The code 726 may cause the processor 722 to store the bowtie charts in the database 730.

The code 726 may also cause the processor 722 to access the database 730 to perform cross-checking and tracing. The database 730 may store a list of activities for the cross checking, and a set of system requirements and a list of components for the tracing.

A method and system herein provide analytical tools for identifying problems and solutions in a complex mechanical system. These tools may be used for various purposes to increase the understanding of a complex mechanical system. Purposes for a space launch vehicle include, but are not limited to, root cause analysis, hazard and safety analysis, arrangement of activities to provide a total mission scenario, and verification and validation efforts to justify program readiness and completeness.

1. A method comprising characterizing a complex mechanical system in terms of functions; and using a computer system to display and fill in bowtie charts to identify problems and solutions with respect to the functions.

2. The method of claim 1, wherein the functions are persistent functions.

3. The method of claim 1, wherein each function corresponds to one of a system, subsystem and component.

4. The method of claim 1, wherein a bowtie chart is presented for each of the persistent functions.

5. The method of claim 1, wherein each bowtie chart identifies one of the functions at a knot, causes of problems with the function on one side of the knot, and corresponding results of the causes on a second side of the knot.

6. The method of claim 5, wherein at least one reason is interposed between a cause and the function, and wherein at least one solution is interposed between the function and a result.

7. The method of claim 6, further comprising decomposing the causes and solutions.

8. The method of claim 6, wherein each bowtie chart identifies a correspondence between the causes/reasons and results/solutions.

9. The method of claim 6, wherein at least some of the reasons and solutions are shared by functions of different bowtie charts.

10. The method of claim 6, wherein the causes and reasons are aligned along first rays extending outward from a first side of the knot, and the results and solutions are aligned along second rays extending outward from a second side of the knot; wherein each first ray terminates in one of the causes, with the reasons for the cause along the first ray; and wherein each second ray corresponds to a first ray and terminates in a result that would be created by the reasons along the corresponding first ray, with solutions to the result along the second ray.

11. The method of claim 6, wherein the computer system generates a bowtie chart for a function by starting with a blank template, filling in the function at the knot, and filling in known causes, reasons, results and solutions; and wherein the computer system is used to add causes, reasons, results and solutions to the bowtie chart over time.

12. The method of claim 6, further comprising tracing each cause in the bowtie chart to a system-level requirement and each reason in the bowtie chart to a subsystem-level requirement.

13. The method of claim 6, further comprising tracing each solution to a component of the system.

14. The method of claim 1, further comprising cross-checking the solutions against a set of scenarios.

15. The method of claim 1, further comprising storing the bowtie charts and associated data for reuse.

16. The method of claim 1, further comprising modifying the complex mechanical system, including implementing at least one of the solutions.

17. A graphical bowtie chart for analyzing a complex mechanical system, the chart generated by a computer, the chart comprising a name of a persistent function of the system at a knot, a set of causes on a first side of the knot, a corresponding set of results on a second side of the knot, at least one reason entry between each cause and the knot, and at least one solution entry between each result and the knot.

18. The computer-generated chart of claim 17, wherein the causes and reasons are aligned along first rays extending outward from the first side of the knot, and the results and solutions are aligned along second rays extending outward from the second side of the knot; wherein each first ray terminates in one of the causes, with the reasons for the cause along the first ray; and wherein each second ray corresponds to a first ray and terminates in a result that would be created by the reasons along the corresponding first ray, with solutions to the result aligned along the second ray.

19. A computer system comprising at least one computer programmed to receive characterizations of a complex mechanical system in terms of functions; and construct charts that identify problems and solutions with respect to the functions, each chart including a name of one of the functions at a knot, a set of causes on a first side of the knot, a corresponding set of results on a second side of the knot, at least one reason between each cause and the knot, and at least one solution between each result and the knot.

20. The computer system of claim 19, wherein each bowtie chart identifies a correspondence between the causes/reasons and results/solutions.

21. The computer system of claim 19, wherein the causes and reasons are aligned along first rays extending outward from a first side of the knot, and the results and solutions are aligned along second rays extending outward from a second side of the knot; wherein each first ray terminates in one of the causes, with the reasons for the cause along the first ray; and wherein each second ray corresponds to a first ray and terminates in a result that would be created by the reasons along the corresponding first ray, with solutions to the result aligned along the second ray.

22. The computer system of claim 19, wherein the computer is programmed to generate each bowtie chart by starting with a blank template, filling in the function at the knot, and filling in known causes, reasons, results and solutions.

23. The computer system of claim 19, wherein at least one computer is further programmed to trace each cause in the bowtie chart to a system-level requirement and each reason in the bowtie chart to a subsystem-level requirement.

24. The computer system of claim 19, wherein at least one computer is further programmed to trace each solution to a component of the complex mechanical system.

25. The computer system of claim 19, wherein at least one computer is further programmed to cross-check the solutions against a set of scenarios.

26. An article comprising computer-readable memory encoded with data for causing a computer system to receive characterizations of a complex mechanical system in terms of functions; and construct bowtie charts that identify problems and solutions with respect to the functions.

27. The article of claim 26, wherein the functions include system-level, subsystem-level, and component-level functions.

28. The article of claim 26, wherein each bowtie chart identifies one of the functions at a knot, problems on one side of the knot, and corresponding results on an opposite side of the knot, at least one reason interposed between each cause and the function at the knot, and at least one solution interposed between each result and the function at the knot.

29. The article of claim 28, wherein the code causes the computer system to place the causes and reasons along first rays extending outward from the first side of the knot, and the results and solutions along second rays extending outward from the second side of the knot; wherein each first ray terminates in one of the causes, with the reasons for the cause along the first ray; and wherein each second ray corresponds to a first ray and terminates in a result that would be created by the reasons along the corresponding first ray, with solutions to the result aligned along the second ray.

30. The article of claim 28, wherein the code causes the computer system to generate each bowtie chart by starting with a blank template, filling in the function at the knot, and filling in known causes, reasons, results and solutions.

31. The article of claim 28, wherein the code causes the computer system to trace each cause in the bowtie chart to a system-level requirement and each reason in the bowtie chart to a subsystem-level requirement.

32. The article of claim 28, wherein the code causes the computer system to trace each solution to a component of the complex mechanical system.

33. The article of claim 28, wherein the code causes the computer system to cross-check the solutions against a set of scenarios.
